(19) United States
(12) Patent Application Publication
(10) Pub. No.: US 2007/0256936 A1
(43) Pub. Date: Nov. 8, 2007

(54) Method for Deashing Syrup by Electrodialysis

(76) Inventors: Robert Jansen, Portella (PT); Anthony Baiada, Dagenham (GB)

Correspondence Address: WILLIAMS, MORGAN & AMERSON, 10333 RICHMOND, SUITE 1100, HOUSTON, TX, 77042, US

(21) Appl. No.: 11/682,985

(22) Filed: Mar. 7, 2007

Related U.S. Application Data
(60) Provisional application No. 60/746,434, filed on May 4, 2006.

(51) Int. Cl. B01D 61/44

(52) U.S. Cl. 204/518

(57) ABSTRACT

We disclose a method of deashing a syrup, comprising replacing polyvalent cations in the syrup with monovalent cations using a cation-exchange resin; replacing polyvalent anions in the syrup with monovalent anions using an anion-exchange resin; electrodialyzing the syrup to remove cations and anions, to yield a deashed syrup and a brine containing monovalent cations and monovalent anions; regenerating the anion-exchange resin by contacting the anion-exchange resin with a brine containing anions, to yield a regenerated anion-exchange resin and a brine depleted in monovalent anions; and regenerating the cation-exchange resin by contacting the cation-exchange resin with a brine containing cations, to yield a regenerated cation-exchange resin and a brine depleted in monovalent cations. The brine containing monovalent cations and monovalent anions can be used in either or both of the regeneration steps and can be concentrated prior to use in either or both regeneration steps. The deashed syrup can be further processed, if desired, but need not be.

This application claims priority from U.S. provisional patent application Ser. No. 60/746,434, filed on May 4, 2006, which is incorporated herein by reference.

### BACKGROUND OF THE INVENTION

The present invention relates generally to the fields of sugar processing. More particularly, it concerns methods for removing ions (ash) from syrup by electrodialysis.

Sugars, such as dextrose, fructose, or sucrose, are typically isolated by a process comprising contacting sugar-containing plant matter with water, to yield a syrup. Common sugar-containing plants include sugar cane and sugar beet, among others, and other sources of sugars include plants that contain starches that can be readily converted to sugars, such as wheat or maize. The syrup generally also contains ions extracted from the plant matter. Such ions are commonly termed “ash.” It is desirable to remove ash from, or deash, a syrup to render it more palatable for consumption in food or drink.

One deashing technique comprises the use of ion exchange resins. The syrup is contacted with a strong acid cation (SAC) resin to remove cations, and is then contacted with a strong base anion (SBA) resin to remove anions. Typically, these steps must be repeated multiple times to deash the syrup to a desirable low level. During this process, the ion-removal abilities of the SAC resin and the SBA resin are reduced, and periodic regeneration of the resins with an excess of acid and base, respectively, is required. The regeneration process yields large quantities of waste material comprising cations eluted off the SAC resin, anions eluted off the SBA resin, and counterions provided by the acid or base, respectively, in excess over the ash content of the original syrup.

It would be desirable to have a deashing technique that generates lower quantities of waste ionic material beyond the ash content of the original syrup.

Another deashing technique involves electrodialysis. The syrup is dialyzed in the presence of an electric field which forces ions from the syrup across a membrane into an ion concentration zone. Although electrodialysis generates less waste material than ion exchange, during the course of electrodialysis, the membrane becomes fouled, and fairly quickly needs replacement. The cost of electrodialysis membrane replacement can be very high. Conventional electrodialysis also can have lower ion removal efficiency than the ion exchange deashing techniques mentioned above.

It would be desirable to have a deashing technique which has lower maintenance and replacement costs than conventional electrodialysis and a greater removal of ions relative to conventional electrodialysis.

### SUMMARY OF THE INVENTION

In one embodiment, the present invention relates to a method of deashing a syrup, comprising replacing polyvalent cations in the syrup with monovalent cations using a cation-exchange resin; replacing polyvalent anions in the syrup with monovalent anions using an anion-exchange resin; electrodialyzing the syrup to remove cations and anions, to yield a deashed syrup and a brine containing monovalent cations and monovalent anions; regenerating the anion-exchange resin by contacting the anion-exchange resin with a brine containing anions, to yield a regenerated anion-exchange resin and a brine depleted in monovalent anions; and regenerating the cation-exchange resin by contacting the cation-exchange resin with a brine containing cations, to yield a regenerated cation-exchange resin and a brine depleted in monovalent cations.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 presents a flow diagram of a method of the present invention.

FIG. 2 shows an electrodialysis stack suitable for use in the present invention.

### DESCRIPTION OF ILLUSTRATIVE EMBODIMENTS

In one embodiment, the present invention relates to a method of deashing a syrup, comprising replacing polyvalent cations in the syrup with monovalent cations using a cation-exchange resin; replacing polyvalent anions in the syrup with monovalent anions using an anion-exchange resin; electrodialyzing the syrup to remove cations and anions, to yield a deashed syrup and a brine containing monovalent cations and monovalent anions; regenerating the anion-exchange resin by contacting the anion-exchange resin with a brine containing anions, to yield a regenerated anion-exchange resin and a brine depleted in monovalent anions; and regenerating the cation-exchange resin by contacting the cation-exchange resin with a brine containing cations, to yield a regenerated cation-exchange resin and a brine depleted in monovalent cations.

A syrup, as used herein, is a composition comprising water and a sugar. In one embodiment, the syrup comprises at least 3 w/v % sugar. In one embodiment, the sugar can be dextrose, fructose, or sucrose. (The word “or,” wherever it is used herein, has the inclusive meaning unless explicitly stated to the contrary). Dextrose and fructose can be made by hydrolysis and saccharification of starch extracted from cereal plants, and sucrose and other sugars can be extracted from several plants, though the skilled artisan will recognize certain species and certain plant structures may have higher concentrations of starch or sugars and may be more economical sources thereof. Common sources of starch to make dextrose and fructose include wheat or maize, and common sources of sugars include sugar cane or sugar beet. These common sources are named as examples only.

When manufacturing sugars, dextrose, or fructose, other materials are also extracted from the plant and are present in the raw syrup and are considered impurities. Among the impurities are generally mono- or polyvalent cations and mono- or polyvalent anions (generally, “ash”). Mono- or polyvalent cations which may be present can include sodium, potassium, calcium, or magnesium. In one embodiment, the monovalent cations can be sodium or potassium. In one embodiment, the polyvalent cations can be calcium or magnesium.

Mono- or polyvalent anions which may be present as ash can include chloride, phosphate, sulfate, or oxalate. In one embodiment, the monovalent anions can be chloride. In one embodiment, the polyvalent anions can be phosphate, sulfate, or oxalate.

In one embodiment, the method can further comprise removing cations from the deashed syrup and removing anions from the deashed syrup.

In one embodiment, the method can further comprise concentrating the brine containing monovalent cations and monovalent anions.

Cation-exchange resins can be further defined as strong acid cation (SAC) resins or weak acid cation (WAC) resins. An SAC resin is a cation-exchange resin with a pKa less than 2. A WAC resin is a cation-exchange resin with a pKa of 2 to 7.

Anion-exchange resins can be further defined as strong base anion (SBA) resins or weak base anion (WBA) resins. An SBA resin is an anion-exchange resin with a pKa of greater than 12. A WBA resin is an anion-exchange resin with a pKa of 7 to 12.

The following table indicates exemplary SAC, WAC, SBA, and WBA resins which are commercially available.
1) Strong acid cation—sulfonate (—SO₃H)
2) Weak acid cation—carboxlyate (—COOH)
3) Strong base anion—quaternary ammonium derivatives eg: Type 1 chloride form (—CH₂N(CH₃)⁺Cl⁻)
4) Weak base anion—tertiary amine—chloride form (—CH₂NHN(CH₃)₂⁺Cl⁻)

In one embodiment, the cation-exchange resin is a weak acid cation (WAC) resin and regenerating the cation-exchange resin further comprises contacting the cation-exchange resin with a strong acid.

In one embodiment, the anion-exchange resin is a strong base anion (SBA) resin.

Part of the problem leading to the short life of electrodialysis membranes in conventional processes is calcium and magnesium ions. Softening the liquid to be treated by electrodialysis has been suggested in the treatment of water. Softening is usually carried out with a cation exchange resin to remove calcium and magnesium ions, but is generally considered expensive and of little benefit (e.g., Mani, U.S. Pat. No. 6,017,433). Others have suggested adding acid to reduce the feed pH to 3.5, to prevent the fouling of the electrodialysis by calcium and magnesium salts and to discourage the growth of microorganisms. However, the acid needs to be removed in the electrodialysis operation, adding to the salt load.

The method provides a deashing method involving electrodialysis which can have a reduced incidence of membrane fouling and a greater removal of ions relative to conventional electrodialysis-based deashing techniques. The method also can reduce the amount of waste generated, relative to conventional ion exchange-based deashing techniques. It also can have reduced costs relative to the conventional use of softening techniques.

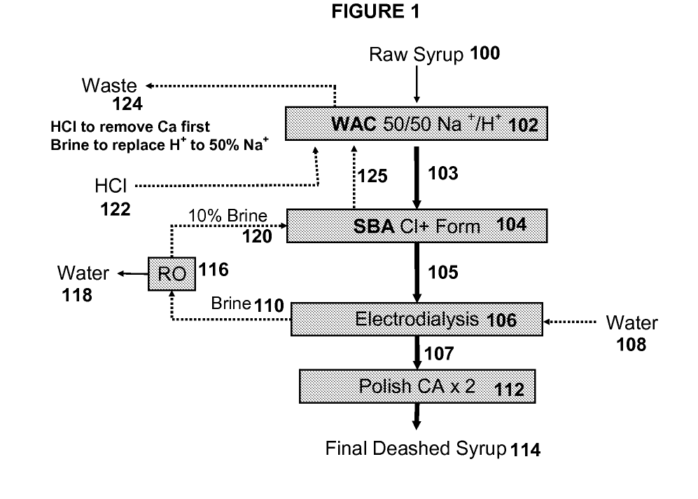

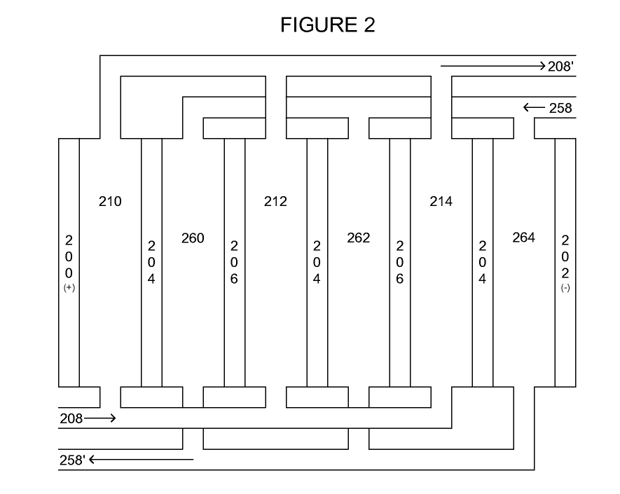

Exemplary embodiments of the present invention are shown in FIGS. 1-2.

Turning to the embodiment shown in FIG. 1, a raw syrup 100 is subjected to a cation-exchange step 102. In the cation-exchange step 102, the syrup 100 is contacted with a cation-exchange resin, such as on a column containing the cation-exchange resin. The cation-exchange resin contains resin beads with anionic groups, and monovalent cations, such as sodium or potassium, are bound to the anionic groups. When the syrup 100 is contacted with the cation-exchange resin, cations, including polyvalent cations, in the syrup compete with the monovalent cations of the cation-exchange resin. Cations formerly in the syrup form bond to the cation-exchange resin anionic groups and monovalent cations formerly bound to the cation-exchange resin anionic groups transfer to the syrup. In this way, the polyvalent cation level in the syrup 103 can be reduced relative to the raw syrup 100. The term “replacing” means that at least some of the polyvalent cations in the syrup at the start of the step are replaced with monovalent cations by the end of the step.

In one embodiment, the monovalent cations are sodium or potassium.

Continuing through FIG. 1, in the anion-exchange step 104, the syrup 103 is contacted with an anion-exchange resin, such as on a column containing the anion-exchange resin. The anion-exchange resin contains resin beads with cationic groups, and monovalent anions, such as chloride, are bound to the cationic groups. When the syrup is contacted with the anion-exchange resin, anions, including polyvalent anions, in the syrup compete with the monovalent anions of the anion-exchange resin. Anions formerly in the syrup form bond to the anion-exchange resin cationic groups and monovalent anions formerly bound to the anion-exchange resin cationic groups transfer to the syrup. In this way, the polyvalent anion level in the syrup 105 can be reduced relative to the raw syrup 100. The term “replacing” means that at least some of the polyvalent anions in the syrup at the start of the step are replaced with monovalent anions by the end of the step.

In one embodiment, the monovalent anions are chloride.

The plural “cations” or “anions” refers to a plurality of charged particles, not necessarily a plurality of ionic species.

In either replacing step, monovalent ions bound to the resin are replaced with polyvalent ions. Periodically, the resin must be regenerated by replacing the polyvalent ions bound to the resin with monovalent ions from a regeneration solution. Regeneration will be discussed in more detail below.

The cation-exchange step and the anion-exchange step can be performed in either order. In FIG. 1, the cation-exchange step 102 is shown first and the anion-exchange step 104 is shown second.

After the replacement of polyvalent cations and polyvalent anions, continuing through FIG. 1, in the electrodialyzing step 106, the syrup 105, from which at least some polyvalent ions have been removed, is electrodialyzed to remove cations and anions, to yield a deashed syrup 107 and a brine 110.

Electrodialysis is a known technique. A schematic representation of an electrodialysis system is shown in FIG. 2. An electrodialysis system typically comprises a stack of alternating cation-transfer membranes 204 and anion-transfer membranes 206, which define alternating feed zones 210, 212, and 214 and concentration zones 260, 262, and 264. The electrodialysis system also comprises an anode 200 at a first end of the stack and a cathode 202 at the other end of the stack. Through the anode 200 and cathode 202, an electric field is applied across the stack such that there is an electrical potential difference between each feed zone (e.g., 212) and each of the concentration zones adjacent thereto (e.g., 260, 262).

In the electrodialysis step, the syrup 105 is fed to a first feed zone (e.g., 212) from feed source 208 and water 108 is fed to both a first concentration zone to the anode side of the first feed zone (e.g., 260) and a second concentration zone to the cathode side of the first feed zone (e.g., 262) from a water source 258. The electric field drives at least some anions from the feed zone 212 toward the anode 200, through an anion-transfer membrane 206 to the first concentration zone 260, and drives at least some cations from the feed zone 212 toward the cathode 202, through a cation-transfer membrane 204 to the second concentration zone 262. The syrup 105 can be fed from the first feed zone 260 to a second feed zone 262, where the same driving of ions occurs, and so forth, or it can be passed only once through the electrodialysis system. The electrodialysis step results in a syrup with a lower ion concentration, i.e., a deashed syrup, at the downstream end 208′ of the feed zones. While the syrup 105 is being fed from feed zone to feed zone, water 108 is fed through the concentration zones. Water is collected from the concentration zones, where it has gained anions and cations, at the downstream end 258′ of the concentration zones. Thus, the electrodialysis step also results in a brine containing monovalent cations and monovalent anions 110, which is used herein to refer to an aqueous solution containing cations and anions and substantially no sugar. The cation need not be sodium, nor does the anion need to be chloride, for a solution to be a brine, as the term is used herein. The brine resulting from the electrodialysis step will comprise primarily monovalent cations and monovalent anions.

We have discovered that prior performance of the cation-exchange step and the anion-exchange step minimizes fouling of the ion-exchange membranes in the electrodialysis system. In the absence of the replacing steps, and despite routine maintenance to minimize bacterial growth and fouling by mineral precipitation, typical membrane life is on the order of weeks. With performance of the replacing steps and routine maintenance, in many cases, membrane life can be of the order of months. This shows clear economic benefit to the present method.

We have also discovered that prior performance of the cation-exchange step and the anion-exchange step enhances ion removal. For example, in the absence of the replacing steps, we have observed electrodialysis can remove about 50% of phosphate anions and about 50-60% of sulfate anions from a dextrose syrup. With performance of the replacing steps, in many cases, electrodialysis can remove about 90% of monovalent anions, such as chloride, from a dextrose syrup.

After electrodialysis, the deashed syrup 107 may still contain some residual ions. Depending on the intended use of the deashed syrup 107, the residual ion content may be undesirably high and further ion removal may be appropriate. Therefore, in one embodiment, the method further comprises removing cations from the deashed syrup 107 and removing anions from the deashed syrup 107, shown collectively in FIG. 1 as two cycles (“×2”) of cation removal and anion removal (“Polish CA”) 112 to yield the final deashed syrup 114. These removing steps can be performed by ion exchange, among other techniques.

As stated above, the cation-exchange resin and the anion-exchange resin require periodic regeneration by treatment with a solution containing monovalent ions. Also as stated above, the electrodialysis step 106 results in a brine 110 containing monovalent ions. Therefore, in one embodiment, the method also involves regenerating either or both resins with a brine 110 originating from the electrodialysis step 106.

Prior to regeneration, it may be desirable to concentrate the brine, such as by reverse osmosis or evaporation, among other techniques known in the art. FIG. 1 shows a concentration step 116 involving reverse osmosis (“RO”), yielding brine at 10% salt 120 and water 118. Concentration, however, may not be necessary, depending on the ion content of the brine and the particular regeneration requirements of either or both resins.

In one embodiment, the method further comprises regenerating the anion-exchange resin with the brine 120, to yield a regenerated anion-exchange resin and a brine depleted in monovalent anions 125. In the regenerating step, polyvalent anions bound to the anion-exchange resin cationic groups are exchanged with monovalent anions in the brine; monovalent anions bond to the anion-exchange resin cationic groups; and monovalent cations from the starting brine and polyvalent anions exchanged with the anion-exchange resin yield a brine depleted in monovalent anions, by which is meant a brine wherein more anions are polyvalent anions than was true prior to regeneration of the anion-exchange resin.

In a further embodiment, the brine depleted in monovalent anions 125 can be used to regenerate the cation-exchange resin. However, calcium salts with polyvalent anions can be insoluble, and thus if calcium is a polyvalent cation bound to cation-exchange resin anionic groups, care should be taken to prevent the formation of insoluble species. Therefore, it can be desirable to regenerate the cation-exchange resin with a strong acid, such as HCl 122 as shown in FIG. 1, as well as the brine depleted in monovalent anions 125. This can be particularly desirable if the cation-exchange resin is a WAC resin. A strong acid, within this embodiment, is hydrochloric acid, nitric acid, or a mixture thereof. If a strong acid is desired, the cation-exchange resin can be first contacted with the strong acid 122, to run off calcium chloride or calcium nitrate salt(s), and yield the protonated forms of the cation-exchange resin anionic groups. Then, the brine depleted in monovalent anions 125 can be used to replace some or all of the protons bound to the cation-exchange resin anionic groups with monovalent cations. Typically, about 50% of the protons are replaced with monovalent cations. The result is a regenerated cation-exchange resin and a brine depleted in monovalent cations, collectively waste 124 in FIG. 1.

When about 50% of the protons are replaced, giving a resin column that is 50/50 in the hydrogen and monovalent cation form, the pH of the dextrose syrup exiting the column will be about pH 5.0, similar to the feed pH. When processing a dextrose syrup it can be useful to keep the pH at pH 5.5 or less to help prevent the growth of microorganisms and to reduce the degree of color formation in subsequent heating during evaporation.

The calcium salts and the brine depleted in monovalent cations, separately or together as waste 124, can be disposed of as waste or used in the preparation of fertilizer or other material. We have discovered the quantity of calcium salts and brine depleted in monovalent cations generated by performance of the method is generally lower than that quantity of salts and brine generated by conventional ion-exchange processes. FIG. 1 shows regeneration of the anion-exchange resin followed by regeneration of the cation-exchange resin.

In another embodiment, the brine resulting from electrodialysis can be used in the regeneration of the cation-exchange resin, possibly with a strong acid as described above, and the resulting brine depleted in monovalent cations can be used in the regeneration of the anion-exchange resin.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLE 1

A dextrose syrup was pre-treated using ion exchange prior to electrodialysis. The pretreatment comprised a single cation column containing 700 L of Purolite C104 and primary and secondary anion columns containing 900 L each of Purolite Styrene A500PS.

The dextrose syrup had a concentration of 30 Brix and temperature of 50° C., and was fed to the columns at 800 L/h. The service time for the cation column was 100 hours and the primary anion column was regenerated after 60 hours.

After pre-treatment, the dextrose syrup was electrodialyzed. The electrodialysis unit was manufactured by Eurodia Industrie, model EUR40B 40 LCD. The unit contained Neosepta membranes manufactured by Tokuyama, Japan. The cationic ion exchange membrane type was CMX SB and the anionic exchange membrane type was AMX SB. The effective membrane area was 16 m².

The dextrose syrup feed to the electrodialysis unit had a concentration of 26 Brix and a temperature of 52° C. The flow rate was 800 L/h and the conductivity was 1200±200 μS.

In the concentration zones, brine was recycled at a flow rate of 800 L/h with the pressure on either side of the membrane balanced at 0.6 bar. The conductivity of the brine was maintained in the range 1.5 to 2.0 millisiemens by adding water and bleeding off the brine. The brine was made up initially using process condensate at 52° C. and 10% HCl to give a conductivity of 1.7 millisiemens.

The operating parameters of the electrodialysis unit included a potential difference across the membrane of 40 V and current usage of 30 A. The unit was run until the efficiency (calculated by conductivity difference) was less than 90%. This was typically 24 hours after which the unit and feed tanks underwent chemical cleaning and regeneration with separate cycles of NaOH (to a concentration of 23 μS) and HCl (40 μS).

Regeneration of the cation columns was performed by first sweetening off until the effluent was less than 1 Brix using process condensate at 3 L/min. 1350 L of 10% HCl was then passed at 3.5 L/min. This was subsequently washed out by process condensate at 2 L/min until the conductivity leaving the column was less than 70 μS. The C104 resin in acid form was converted to 50% sodium form using 2000 L of 3% NaOH at a flow rate of 4 L/min. Before being put into service the excess chemicals were flushed out using process condensate at 2 L/min until the effluent had a conductivity of less than 70 μS.

The anion columns were first sweetened off under the same conditions as the cation columns. The regeneration was then performed using 560 L of a 10% NaCl solution and 120 L of 2% NaOH solution passed at 2.5 L/min. The excess chemicals were washed out using process condensate at 2 L/min until the solution leaving the column had a conductivity of less than 70 μS.

### EXAMPLE 2

Take about 1 cubic meter of dilute brine produced by the electrodialysis unit during its running time deashing syrup. This is a dilute solution of the salt that is being removed from the sugar solution being processed by the electrodialysis unit.

This brine solution is then concentrated using a reverse osmosis system. The reverse osmosis is a membrane system that uses high pressure to separate water from dilute salt solutions. The reverse osmosis is done using two 4 in diameter Osmonics water treatment membranes. The brine is concentrated until it is about 8% concentration.

Set up two 100 ml glass columns as resin columns with 50 ml of strong base anion (SBA) resin in one and 50 ml of weak acid cation (WAC) resin in the other. The resin used should be exhausted resin taken from the columns used for pre-treatment prior to the electrodialysis unit, as described in Example 1.

Mix caustic soda into the brine obtained after concentration by reverse osmosis. The quantity of caustic soda should be 2% of the sodium chloride content. Use this brine and caustic soda mix to regenerate the strong base anion resin (SBA). Set the flow of this material at 25 ml per hour and regenerate for about one bed volume. Collect the effluent from the column.

Carry out the first stage of regeneration of the weak acid cation resin using 100 ml of 10% hydrochloric acid. Discard the effluent from this part regeneration.

Carry out the second stage of the regeneration of the weak acid cation (WAC) using the effluent from the regeneration of the strong base anion. This material should be passed through the column at a rate of 25 ml per hour and a total of 100 ml should be sufficient for regeneration.

After the above treatments, both of the resins, the strong base anion resin and the weak acid cation resin, should be sufficiently regenerated to allow effective pre-treatment of sugar or dextrose prior to processing by elecrodialysis.

All of the methods disclosed and claimed herein can be made and executed without undue experimentation in light of the present disclosure. While the methods of this invention have been described in terms of preferred embodiments, it will be apparent to those of skill in the art that variations may be applied to the methods and in the steps or in the sequence of steps of the methods described herein without departing from the concept, spirit and scope of the invention. More specifically, it will be apparent that certain agents which are chemically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A method of deashing a syrup, comprising:
replacing polyvalent cations in the syrup with monovalent cations using a cation-exchange resin;
replacing polyvalent anions in the syrup with monovalent anions using an anion-exchange resin;
electrodialyzing the syrup to remove cations and anions, to yield a deashed syrup and a brine containing monovalent cations and monovalent anions;
regenerating the anion-exchange resin by contacting the anion-exchange resin with a brine containing anions, to yield a regenerated anion-exchange resin and a brine depleted in monovalent anions; and
regenerating the cation-exchange resin by contacting the cation-exchange resin with a brine containing cations, to yield a regenerated cation-exchange resin and a brine depleted in monovalent cations.

2. The method of claim 1, wherein the syrup comprises dextrose, fructose, or sucrose.

3. The method of claim 1, wherein the monovalent cations are sodium or potassium.

4. The method of claim 1, wherein the monovalent anions are chloride.

5. The method of claim 1, further comprising removing cations from the deashed syrup and removing anions from the deashed syrup.

6. The method of claim 1, further comprising concentrating the brine containing monovalent cations and monovalent anions.

7. The method of claim 6, wherein the concentrated brine is used in either or both regenerating steps.

8. The method of claim 1, wherein the polyvalent cations are calcium or magnesium.

9. The method of claim 1, wherein the polyvalent anions are phosphate, sulfate, or oxalate.

10. The method of claim 1, wherein the cation-exchange resin is a weak acid cation (WAC) resin and regenerating the cation-exchange resin further comprises contacting the cation-exchange resin with a strong acid.

11. The method of claim 1, wherein the anion-exchange resin is a strong base anion (SBA) resin.
